(19) United States
(12) Patent Application Publication
(10) Pub. No.: US 2011/0040981 A1
(43) Pub. Date: Feb. 17, 2011

(54) Synchronization of Buffered Audio Data With Live Broadcast

(75) Inventors: Aram Lindahl, Menlo Park, CA (US); Richard Michael Powell, Mountain View, CA (US); Joseph M. Williams, Dallas, TX (US)

Correspondence Address: APPLE INC.;c/o Fletcher Yoder, PC, P.O. Box 692289, Houston, TX, 77269-2289, US

(73) Assignee: Apple Inc., Cupertino, CA (US)

(21) Appl. No.: 12/541,803

(22) Filed: Aug. 14, 2009

(51) Int. Cl. G06F 17/00; G06F 12/14; G06F 15/16

(52) U.S. Cl. 713/189; 700/94; 709/247

(57) ABSTRACT

Various techniques relating to the buffering of a live audio broadcast on an electronic device and the subsequently playback the buffered data are provided. In one embodiment, the playback speed of the buffered data may be increased relative to the actual speed at which the data was originally broadcasted. If the buffered playback (using the increased playback speed) synchronizes or catches up to the live broadcast, the electronic device may disable buffering and output the live stream instead. This decreases processing demands by lowering processing cycles required for buffering (encoding, etc.) and playback of the buffered data (decoding, etc.), thereby reducing power consumption.

### BACKGROUND

The present disclosure relates generally to the playback of a buffered radio broadcast and, more particularly, to techniques for synchronizing the buffered playback with the live broadcast through adjustment of a playback speed.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Radio programming, which may include both terrestrial broadcasts (e.g., AM, FM) and satellite broadcasts (e.g., XM Satellite Radio and Sirius Satellite Radio, both currently operated by Sirius XM, Inc., of New York City, N.Y.), typically broadcasts a wide variety of content, such as music, talk shows, sporting events, news programs, comedy programs, and drama programs, to name just a few. Further, with the exception of some subscription-based satellite radio services, most radio broadcasts are generally free of cost and readily accessible through most electronic devices that include an appropriate receiver, such as an antenna, and tuning components for selecting a particular radio frequency or band of frequencies. For instance, electronic devices that provide for the playback of radio programs may include non-portable electronic devices, such as a stereo system in a home or automobile, as well as portable electronic devices, such as portable digital media players having integrated radio antenna(s) and tuners. Accordingly, due to the diversity of available programming content and the relative ease of access to radio broadcasts, many individuals listen to the radio throughout the day as a form of entertainment (e.g., sporting events, talk shows) or leisure (e.g., music broadcasting), or for informative purposes (e.g., news reports).

Typically, radio programming follows a predetermined broadcast schedule, such that each program is broadcasted at a particular scheduled or designated time. Thus, in order to listen to a live broadcast (e.g., in real-time) of a particular radio program, an individual would generally need to be tuned to the particular station at the scheduled time of the radio program. However, there may be times at which an individual may not be able to tune in to a particular radio program at the start of its designated broadcast time, thus missing all or a portion of the program. As such, it may be convenient to provide techniques by which radio broadcasts may be buffered (e.g., stored) on an electronic device for playback at a later time. Further, due to power limitations on some electronic devices, particularly portable digital media players that rely on a limited quantity of battery power, it may also be beneficial to provide techniques for reducing overall power consumption during playback of the audio broadcast data.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

The present disclosure generally relates to techniques for buffering a live audio broadcast on an electronic device and playing back the buffered data. In one embodiment, the playback speed of the buffered data may be increased relative to the normal (e.g., actual) speed at which the data was originally broadcasted. If the buffered playback (using the increased speed) synchronizes or catches up to the live broadcast, the electronic device may disable buffering and output the live stream instead. This decreases processing demands by lowering processing cycles required for buffering (encoding, etc.) and playback of the buffered data (decoding, etc.), thereby reducing power consumption. As will be appreciated, one or more aspects of the buffered playback techniques described herein may be configured via user preference settings on the electronic device.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. Again, the brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a block diagram of an electronic device that includes processing logic configured to provide for buffering and playback of audio broadcast data, in accordance with aspects of the present disclosure;

FIG. 2 is a front view of a handheld electronic device, in accordance with aspects of the present disclosure;

FIG. 3 is a more detailed block diagram showing the processing logic that may be implemented in the electronic device of FIG. 1, in accordance with aspects of the present disclosure;

FIG. 4 is a graphical timeline depicting the live broadcast of an audio program and the buffered playback of the audio program without playback speed adjustments;

FIG. 5 is a graphical timeline depicting the live broadcast of an audio program and the buffered playback of the audio program at an increased playback speed, such that the buffered playback eventually synchronizes with the live broadcast, in accordance with aspects of the present disclosure;

FIG. 6. is a flow chart depicting a process for synchronizing the playback of a buffered audio program with a corresponding live broadcast, in accordance with the embodiment shown in FIG. 5;

FIG. 7 is a graphical timeline depicting the live broadcast of an audio program and the buffered playback of the audio program using at least one increased playback speed, wherein the buffered playback of the audio program may include playing essential portions of the audio program using a first increased playback speed and playing non-essential portions of the audio program using a second increased playback speed, or playing essential portions of the audio program using the first increased playback speed while omitting the playback of the non-essential portions of the audio program altogether, such that the buffered playback eventually synchronizes with the live broadcast, in accordance with aspects of the present disclosure;

FIG. 8 is a flow chart depicting a process for synchronizing the playback of a buffered audio program with a corresponding live broadcast, in accordance with the embodiment shown in FIG. 7; and

FIG. 9 shows a plurality of screens that may be displayed on the device of FIG. 2 illustrating various options that may be configured by a user with regard to the playback of a buffered audio program, in accordance with aspects of the present disclosure.

### DETAILED DESCRIPTION OF SPECIFIC EMBODIMENTS

One or more specific embodiments of the present disclosure will be described below. These described embodiments are only examples of the presently disclosed techniques. Additionally, in an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

As will be discussed below, the present disclosure relates generally to techniques for playing back a buffered radio program on an electronic device using an increased playback speed, such that the buffered playback synchronizes with the live broadcast of the radio program after a particular amount of time, which may depend on the increased playback speed. For instance, in certain embodiments, the electronic device may begin buffering the radio program at the start of its scheduled or designated broadcast time. This may include encoding and storing a digital representation of the radio program on the electronic device. Thus, a listener that is unable to tune in and listen to the radio program as it is being broadcasted in real time may still hear the entirety of the program at a later time by playing back the buffered radio program on the electronic device. During this time, the electronic device may continue to buffer the live broadcast, while decoding and playing back an earlier portion of the radio program.

Further, in accordance with the presently disclosed techniques, the speed at which the buffered radio program is played back may be adjusted (e.g., increased), such that the playback of the buffered radio program eventually synchronizes or “catches up” to the live broadcast. At this point, based upon one or more user preferences, the electronic device may be configured to stop buffering the radio program and simply play back the live stream. As will be appreciated, this lowers over processing demands by reducing the need to buffer, encode, and/or store the on the electronic device, thereby reducing overall power consumption and, in the case of portable electronic devices, prolonging battery life.

Before continuing, several of the terms used throughout the present disclosure will be first defined in order to facilitate a better understanding of disclosed subject matter. For instance, as used herein, the term “audio broadcast,” “audio program,” “radio broadcast,” “radio program,” or the like, shall be understood to encompass both terrestrial broadcasts (e.g., via frequency modulation (FM) or amplitude modulation (AM)) and satellite broadcasts (e.g., XM® or Sirius®, both currently operated by Sirius XM, Inc.). Additionally, it should be understood that FM and AM broadcasting may include both conventional analog broadcasting, as well as newer digital terrestrial broadcast standards, such as HD Radio® (e.g., using in-band on-channel (IBOC) technologies) or FMeXtra®, for example.

Also, as used herein, the term “buffering” or the like shall be understood to refer to the storage of digital representation of a live audio broadcast on an electronic device, and the term “playback” or “buffered playback” or the like shall be understood to refer to the playback of the stored digital representation on the electronic device. As will be appreciated, buffering may include one or more of receiving, encoding, compressing, encrypting, and writing audio data to a storage device, and playback may include retrieving the audio data from the storage device and one or more of decrypting, decoding, decompressing, and outputting an audio signal to an audio output device.

Further, the term “live,” as applied to radio broadcasts, should be understood to mean the act of transmitting radio waves representing a particular radio program, which may be accomplished using terrestrial radio towers, satellites, or through a network (e.g., the Internet). A live broadcast may correspond to substantially real-time events (e.g., news report, live commentary from a sporting event or concert) or to previously recorded data (e.g. replay of an earlier-recorded live radio program). Thus, to be clear, while the actual content of a radio broadcast may not necessarily correspond to live events (e.g., occurring in substantially real-time), the transmission of the broadcasted audio data is “live” in the sense that such transmissions are occurring in substantially real-time. Additionally, the terms “normal” or “default,” when used in describing the speed at which a buffered audio program is played, shall be understood to mean the actual speed at which the radio program was originally broadcasted. In other words, a buffered audio program that is played back at a normal or default speed would sound substantially identical to the original live broadcast.

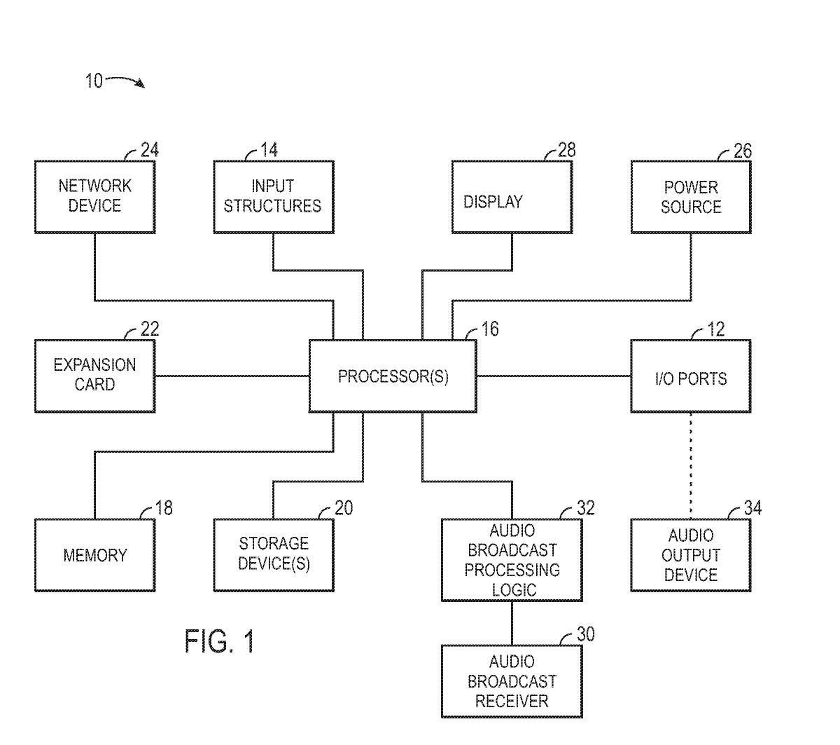

Keeping the above points in mind, FIG. 1 is a block diagram illustrating an example of an electronic device 10 that may provide for the buffering and playback of a broadcasted audio program, in accordance with aspects of the present disclosure. Electronic device 10 may be any type of electronic device, such as a portable media player, a laptop, a mobile phone, or the like, that includes a receiver (e.g., 30) configured to receive audio broadcast data. By way of example only, electronic device 10 may be a portable electronic device, such as a model of an iPod® or iPhone®, or a desktop or laptop computer, such as a model of a MacBook®, MacBook® Pro, MacBook Air®, iMac®, Mac® Mini, or Mac Pro®, available from Apple Inc. of Cupertino, Calif. In other embodiments, electronic device 10 may also be a model of an electronic device from another manufacturer that is capable of receiving and processing audio broadcast data. As will be discussed further below, electronic device 10 may be configured to playback a buffered audio program using an increased playback speed such that the buffered playback eventually synchronizes or “catches up” to the live broadcast, at which point, buffering may be discontinued, thus reducing the overall power consumption.

As shown in FIG. 1, electronic device 10 may include various internal and/or external components which contribute to the function of device 10. Those of ordinary skill in the art will appreciate that the various functional blocks shown in FIG. 1 may comprise hardware elements (including circuitry), software elements (including computer code stored on a computer-readable medium) or a combination of both hardware and software elements. For example, in the presently illustrated embodiment, electronic device 10 may include input/output (I/O) ports 12, input structures 14, one or more processors 16, memory device 18, non-volatile storage 20, expansion card(s) 22, networking device 24, power source 26, display 28, audio broadcast receiver 30, audio broadcast processing logic 32, and audio output device 34.

I/O ports 12 may include ports configured to connect to a variety of external devices, including audio output device 34. In one embodiment, output device 34 may include external headphones or speakers, and I/O ports 12 may include an audio input port configured to couple audio output device 34 to electronic device 10. For instance, I/O ports 12 may include a 2.5 mm port, 3.5 mm port, or 6.35 mm (¼ inch) audio connection port, or a combination of such audio ports. In other embodiments, audio output device 34 may also include speakers integrated with device 10. Additionally, I/O port 12 may include a proprietary port from Apple Inc. that may function to charge power source 26 (which may include one or more rechargeable batteries) of device 10, or transfer data between device 10 and an external source.

Input structures 14 may provide user input or feedback to processor(s) 16. For instance, input structures 14 may be configured to control one or more functions of electronic device 10, such as applications running on electronic device 10. By way of example only, input structures 14 may include buttons, sliders, switches, control pads, keys, knobs, scroll wheels, keyboards, mice, touchpads, and so forth, or some combination thereof. In one embodiment, input structures 14 may allow a user to navigate a graphical user interface (GUI) displayed on device 10. Additionally, input structures 14 may include a touch sensitive mechanism provided in conjunction with display 28. In such embodiments, a user may select or interact with displayed interface elements via the touch sensitive mechanism.

Processor(s) 16 may include one or more microprocessors, such as one or more “general-purpose” microprocessors, application-specific processors (ASICs), or a combination of such processing components. For example, processor(s) 16 may include instruction set processors (e.g., RISC), graphics/video processors, audio processors, and/or other related chipsets. Processor(s) 16 may provide the processing capability to execute applications on device 10, such as a media player application, and play back digital audio data stored on device 10 (e.g., in storage device 20). In one embodiment, processor(s) 16 may also include one or more digital signal processors (DSP) for encoding, compressing, and/or encrypting audio broadcast data received via receiver 30.

Instructions or data to be processed by processor(s) 16 may be stored in memory 18, which may be a volatile memory, such as random access memory (RAM), or as a non-volatile memory, such as read-only memory (ROM), or as a combination of RAM and ROM devices. For example, memory 18 may store firmware for electronic device 10, such as an operating system, applications, graphical user interface functions, or any other routines that may be executed on electronic device 10. In addition, memory 18 may be used for buffering or caching data during operation of electronic device 10, such as for caching audio broadcast data prior to encoding and compression by audio broadcast processing logic 32.

The components shown in FIG. 1 may further include non-volatile storage device 20, such as flash memory, a hard drive, or any other optical, magnetic, and/or solid-state storage media, for persistent storage of data and/or instructions. By way of example, non-volatile storage 20 may be used to store data files, including audio data, video data, pictures, as well as any other suitable data. As will be discussed further below, non-volatile storage 20 may be utilized by device 10 in conjunction with audio broadcast receiver 30 and audio broadcast processing logic 32 for the storage of audio broadcast data.

Electronic device 10 also includes network device 24, which may be a network controller or a network interface card (NIC) that may provide for network connectivity over a wireless 802.11 standard or any other suitable networking standard, such as a local area network (LAN), a wide area network (WAN), such as an Enhanced Data Rates for GSM Evolution (EDGE) network, a 3G data network, or the Internet. In certain embodiments, network device 24 may provide for a connection to an online digital media content provider, such as the iTunes® music service, available from Apple Inc., or may be used to access, stream, or download Internet-based radio broadcasts (e.g., podcasts).

Display 28 may be used to display various images generated by device 10, such as a GUI for an operating system or for the above-mentioned media player application. Display 28 may be any suitable display such as a liquid crystal display (LCD), plasma display, or an organic light emitting diode (OLED) display, for example. Additionally, display 28 may be provided in conjunction with the above-discussed touch-sensitive mechanism (e.g., a touch screen) that may function as part of a control interface for device 10.

As mentioned above, electronic device 10 may include receiver 30, which may be configured to receive live audio broadcast data. For example, in one embodiment, receiver 30 may include one or more antennas configured to receive analog (e.g., AM and FM broadcasts) and digital (e.g., satellite radio or HD Radio®) broadcast signals. In another embodiment, receiver 30 may, in conjunction with network device 24, further be configured to receive digital audio broadcasts transmitted over a network, such as the Internet, though it should be understood that such broadcasts may be on-demand, and may not always constitute live broadcasts, as defined above. Additionally, it should be understood that receiver 30 may include tuning components to enable device 10 to select a desired signal from a particular radio frequency (e.g., corresponding to a particular radio station).

Audio broadcast data received by receiver 30 may be further processed by audio broadcast processing logic 32 for live playback through audio output device 34 which, as discussed above, may include integrated speakers or external headphones or speakers (connected to device through an I/O port 12). Processing logic 32 may also provide for buffering (e.g., encoding, compressing, encrypting, and/or storing) of the received audio broadcast data on device 10 for subsequent playback at a later time. Thus, when device 10 is configured to buffer a particular audio broadcast, a user that has missed the beginning portion of the live broadcast may still hear the broadcast in its entirety by playing back the buffered data. To provide an example, if an audio program is 75 minutes long beginning from 6:00 PM to 7:15 PM, and the user is unable to tune in until 20 minutes into the live broadcast (e.g., at 6:20 PM), the user may still hear the live broadcast in its entirety from the beginning by playing back the buffered data. In this case, processing logic 32 may continue to encode the current live broadcast stream while decoding earlier buffered samples, such that the entirety of the live broadcast is buffered concurrently with the playback of earlier buffered portions of the broadcast. Thus, in this scenario, the buffered playback and the live broadcast are time-shifted by 20 minutes.

Further, as discussed above, audio broadcast processing logic 32 may also be configured to playback the buffered audio program at an increased playback speed, i.e., faster than the normal speed (as defined above). Thus, depending on the length of the live broadcast and the factor by which the buffered playback speed is increased, the buffered playback may eventually synchronize or “catch up” with the live broadcast. Once the buffered data and the live broadcast are synchronized, processing logic 32 may be configured to stop buffering the live stream, thereby reducing processor load (e.g., for encoding, compressing, encryption, etc.) and lowering power consumption. Various techniques relating to the synchronization of the buffered data and the live broadcast are discussed further below.

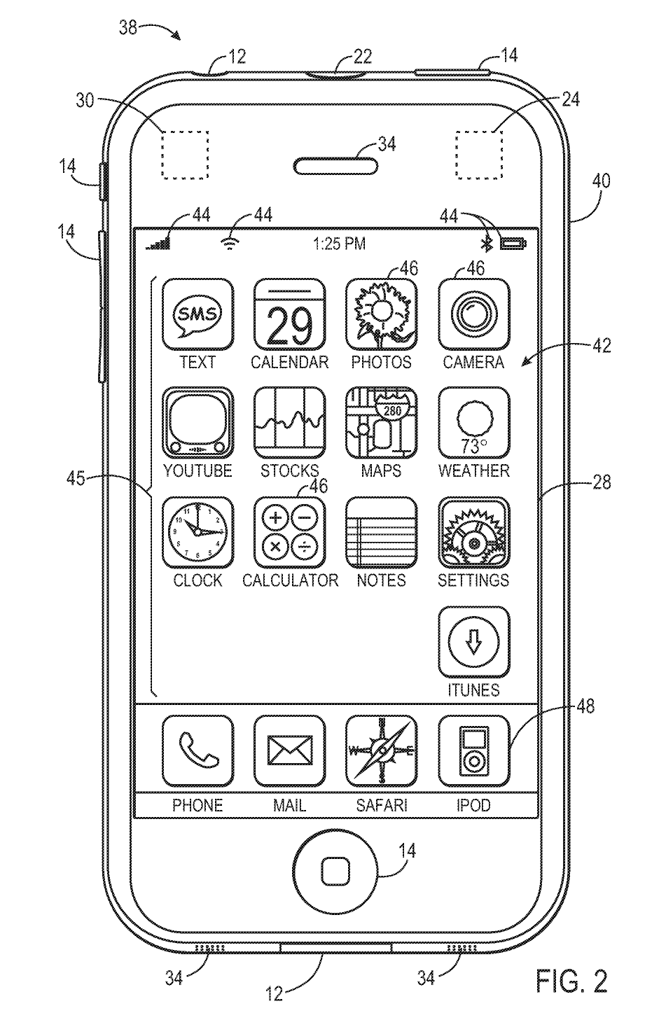

Referring now to FIG. 2, electronic device 10 is illustrated in the form of portable handheld electronic device 38, which may be a model of an iPod® or iPhone® available from Apple Inc. In the depicted embodiment, handheld device 38 includes enclosure 40, which may function to protect the interior components from physical damage and to shield them from electromagnetic interference. Enclosure 40 may be formed from any suitable material or combination of materials, such as plastic, metal, or a composite material, and may allow certain frequencies of electromagnetic radiation, such as radio carrier signals or wireless networking signals, to pass through to audio broadcast receiver 30 or to wireless communication circuitry (e.g., network device 24), both of which may be disposed within enclosure 40, as shown in FIG. 2.

As shown, enclosure 40 includes user input structures 14 through which a user may interface with handheld device 38. For instance, each input structure 14 may be configured to control one or more respective device functions when pressed or actuated. By way of example, one or more of input structures 14 may be configured to invoke a “home” screen 42 or menu to be displayed, to toggle between a sleep, wake, or powered on/off mode, to silence a ringer for a cellular phone application, to increase or decrease a volume output, and so forth. It should be understood that the illustrated input structures 14 are merely exemplary, and that handheld device 38 may include any number of suitable user input structures existing in various forms including buttons, switches, keys, knobs, scroll wheels, and so forth.

In the illustrated embodiment, handheld device 38 includes display 28 in the form of a liquid crystal display (LCD). The LCD 28 may display various images generated by handheld device 38. For example, the LCD 28 may display various system indicators 44 providing feedback to a user with regard to one or more states of handheld device 38, such as power status, signal strength, external device connections, and so forth. LCD 28 may also display graphical user interface (“GUI”) 45 that allows a user to interact with handheld device 38. GUI 45 may include various layers, windows, screens, templates, or other graphical elements that may be displayed in all, or a portion, of LCD 28. For instance, as shown on home screen 42, GUI 45 may include graphical elements representing applications and functions of device 38. The graphical elements may include icons 46 that correspond to various applications that may be opened or executed upon detecting a user selection (e.g., via a touch screen included in display 28 or via input structures 14) of a respective icon 46. By way of example, one of the icons 46 may represent a media player application 48, which may provide for the playback of digital audio and video data stored on device 38, as well as the playback of live and/or buffered audio broadcast programs. In some embodiments, the selection of an icon 46 may lead to a hierarchical navigation process, such that selection of an icon 46 leads to a screen that includes one or more additional icons or other GUI elements.

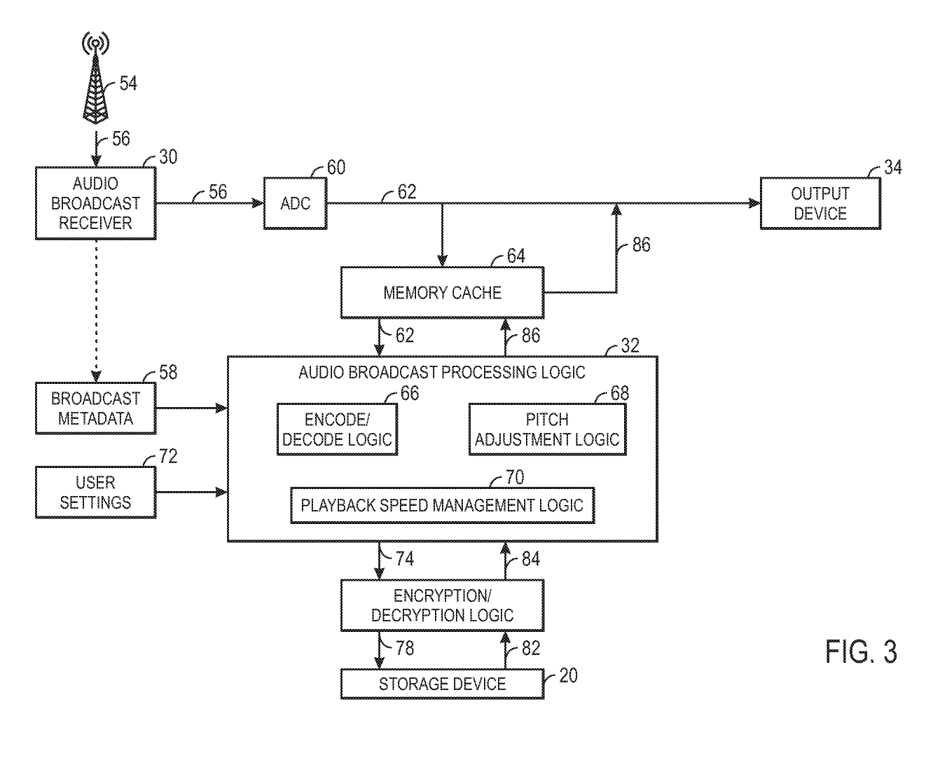

Referring to FIG. 3, a more detailed view of an example of audio broadcast processing logic 32 is illustrated, in accordance with one embodiment. As mentioned above, audio broadcast processing logic 32 may provide for the buffering of a live audio program, and the subsequent playback of the buffered audio program at normal or increased playback speeds. As shown in FIG. 3, audio broadcast processing logic 32 may communicate with receiver 30 that receives audio broadcast signals 56 from broadcasting station 54, which may be a terrestrial radio tower or a satellite. In some embodiments, audio broadcast receiver 30 may also receive a sub-carrier metadata signal 58 associated with audio broadcast 56. For example, broadcast metadata 58 could be a Radio Data System (RDS) data signal associated with an FM signal, an Amplitude Modulation Signaling System (AMSS) data signal associated with an AM signal, or Program Associated Data (PAD) and Program Service Data (PSD) data signals associated with digital radio signals (e.g., satellite or IBOC broadcasting). Additionally, processing logic 32 may also provide for live playback of the audio broadcast by routing the broadcast signal to output device 34. It should be understood that the buffering (e.g., encoding, compression, and storage) of the audio broadcast by processing logic 32 may occur independently of live playback through output device 34. For instance, processing logic 32 may encode and store the audio broadcast with or without live playback, and a user may subsequently access the stored audio broadcast for playback at a later time.

As shown in FIG. 3, audio broadcast signal 56 is received by electronic device 10 using receiver 30. Where signal 56 is an analog signal, such as a conventional FM or AM broadcast signal, analog-to-digital converter 60 may be provided for conversion of signal 56 into a digital equivalent signal 62. Alternatively, where the audio broadcast 56 and metadata 58 signals are transmitted digitally from source 54, such as by way of satellite broadcasting or through the use of digital FM or AM broadcasting technologies (e.g., IBOC, HD Radio®), the digital signals may be processed directly by processing logic 32 (e.g., without use of analog-to-digital converter 60). As part of the encoding process shown in FIG. 3, digital audio broadcast data 62 is first buffered in memory cache 64. Memory cache 64 may be a dedicated memory within processing logic 32, or may be part of memory device 18 of electronic device 10. The buffered broadcast data 62 is then sent to audio processing logic 32, which may include, encode/decode logic 66, pitch adjustment logic 68, and playback speed management logic 70.

Encode/decode logic 66 may be configured to apply an audio codec to encode and compress audio broadcast data 62 into a format that may be stored on storage device 20. For example, encode/decode logic 66 may employ Advanced Audio Coding (AAC or HE-ACC), Apple Lossless Audio Codec (ALAC), Ogg Vorbis, MP3, MP3Pro, MP4, Windows Media Audio, or any suitable music encoding format. In some embodiments, speech codecs, such as Adaptive Multi-Rate (AMR) and Variable Multi-Rate (VMR), may also be utilized by encode/decode logic 66 depending on the type of audio program that is being encoded. As will be appreciated, the codec or codecs utilized by encode/decode logic 66 may be specified through user settings 72 stored on device 10, or may be determined by analyzing metadata information 58. In some embodiments, user settings 72 may also specify a particular compression bit-rate that may be used by encode/decode logic 66 in compressing the encoded data. As discussed above, a digital signal processor (DSP), which may be part of processor(s) 16, may be provided to carry out the encoding/compression functions.

Once broadcast data 62 is encoded and/or compressed, encoded broadcast data, referred to by reference number 74, may be encrypted using encryption/decryption logic 76 prior to being stored on electronic device 10. As can be appreciated, encryption of encoded broadcast data 74 may be applied to prevent circumvention of copyright and other related legal issues. In certain embodiments, encryption/decryption logic 74 may perform encryption/decryption based upon the Advanced Encryption Standard (AES), the Data Encryption Standard (DES), or any other suitable encryption technique. Encryption/decryption logic 74 may be separate from processing logic 32, as shown in FIG. 3, or may also be integrated with processing logic 32 in other embodiments. Encrypted broadcast data 78 may then be stored in non-volatile storage device 20. As discussed above, storage device 20, in some embodiments, may include a flash memory device, such as a NAND flash memory. In such embodiments, one or more wear-leveling techniques may be utilized by the flash memory device, such that erasures and writes are distributed evenly across the flash memory arrays, thereby preventing premature block failures due to a high concentration of writes to one particular area.

In addition to buffering the audio broadcast data 62 in storage 20, audio broadcast processing logic 32 may also provide for playback of the buffered audio data, referred to here by reference number 82, through decryption, decompression, and decoding. For instance, upon selection of buffered audio broadcast data 82 for playback, data 82 is first decrypted by encryption/decryption logic 76. Decrypted data 84 may then be decoded and/or decompressed by encoder/decoder logic 66. As mentioned above, audio broadcast processing logic 32 may also provide for the playback of the buffered audio data at normal or increased playback speeds. In the presently illustrated embodiment, processing logic 32 includes playback speed management logic 70, which may be configured to determine a buffered playback speed based, for example, upon user settings 72, whether the audio data is speech or music data, or whether the audio data is an “essential” or “non-essential” portion of the audio program. Further, purposes of the subsequently discussed examples, a normal playback speed shall be referred to “1× playback,” and increased playback speeds may be expressed as multiples or factors of the normal playback speed. For instance, an increased playback speed that is twice the normal speed may be referred as “2× playback,” and so forth.

In one embodiment, different increased playback speeds may be applied to the buffered playback by playback speed management logic 70 depending on whether the audio data is speech or music data. As will be appreciated, due to the aesthetic nature of music, noticeably altering the speed at which the music is played back may diminish the aesthetic qualities of the music data. Accordingly, to preserve at least an acceptable amount of intelligibility and aesthetic quality in the buffered music playback, playback speed management logic 70 may, in some embodiments, limit the increased playback speed to a 5 to 10 percent increase (e.g., 1.05× to 1.10×) from the normal speed. It should be understood, however, that greater playback speeds could also be selected based on a user's own subjective perception of whether the faster playback of music is aesthetically acceptable. Speech data, however, generally lacks the same aesthetic qualities of music and, therefore, may be tolerable to even higher playback speeds, such as up to 2× or 3×, while still retaining an acceptable amount of intelligibility when heard by the user. Additionally, processing logic may also include pitch adjustment logic 68, which may adjust the pitch of sped-up audio data in order to match the original pitch of the audio data (e.g., if it were to be played back at normal speed). As will be appreciated, pitch adjustment logic 68 may implement one or more time-stretching techniques and/or algorithms in performing pitch adjustment.

With the above points in mind, it should be appreciated that the determination of whether the buffered audio playback constitutes speech data or music data may be specified by user settings 72. For instance, when initiating buffered playback of the audio data 82, a user with knowledge of whether audio data 82 is speech-based or music-based may specify an appropriate increased playback speed in user settings 72. Additionally, playback speed management logic 70 may determine the genre of the buffered audio playback by analyzing corresponding broadcast metadata information 58, or by performing frequency analysis on broadcast signal 62 to determine whether it exhibits speech-like or music-like characteristics.

Playback speed management logic 70 may also be configured to use varying playback speeds by distinguishing between essential and non-essential portions of the buffered audio program. As will be understood, a “non-essential” portion of an audio program may refer to a portion that is not directly related to the audio program and does not necessarily need to be heard in order to appreciate the full program, and “essential” portions of the audio program are generally everything that is not a “non-essential” portion. By way of example, a non-essential portion of an audio program may include commercial advertisements or DJ chat or banter during breaks between essential portions of the program (e.g., between songs, during intermissions, etc.).

In one embodiment, the determination of essential and non-essential portions of buffered data 82 may be based upon associated metadata information 58, which may include data identifying non-essential segments, such as commercials. Further, since non-essential portions of the broadcast generally do not contribute to a listener's appreciation or enjoyment of audio program 56, the buffered playback of such non-essential portions may be played at speeds that reduce intelligibility (e.g., 2.5×, 3×, 4×, or greater). Further, in another embodiment, playback speed management logic 70 may be configured to omit non-essential portions of the audio program 56 from the buffered playback. Thereafter, the decoded and decompressed data 86 may then be buffered in memory cache 68. Though not shown in FIG. 3, those skilled in the art will appreciate that some embodiments may also include digital-to-analog conversion circuitry for converting decoded data 86 back into an analog signal prior to being output to audio output device 34.

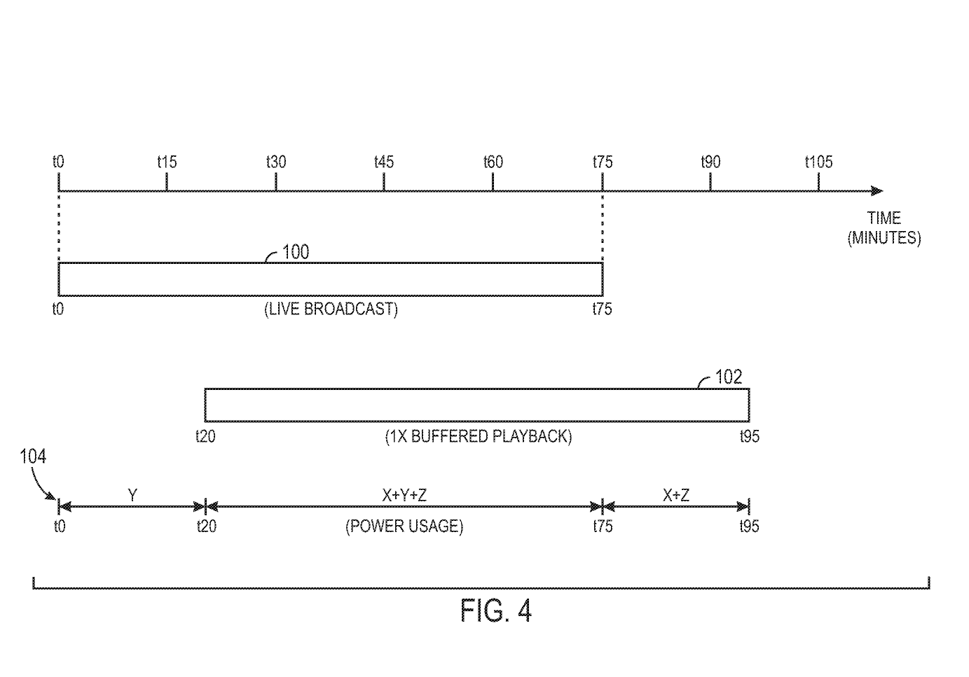

As discussed above, in embodiments where an increased speed is used during buffered playback, the buffered audio data may eventually synchronize (e.g., catch up) to the live broadcast. For instance, during buffered playback, audio broadcast processing logic 32 may continue to analyze the live broadcast stream and, when it is detected that the buffered playback has caught up to the live stream, buffering of the live stream (e.g., broadcast data 62) may be stopped. As will be appreciated, this may reduce processing cycles required for encoding, compressing, encrypting, and or storing the buffered data, thereby lowering overall power consumption and prolonging battery life. Various examples that further illustrate the synchronization of buffered and live data, as well as the power implications of such techniques, will now be described with reference to FIGS. 4-8 below.

Referring to FIG. 4, a graphical timeline depicting the buffered playback 102 of a live broadcast 100 at a normal speed is illustrated. As shown, live broadcast 100 may be a 75 minute audio program that is broadcasted from time t0 to time t75, and device 10 may be configured to start buffering live broadcast 100 beginning at time t0. Assuming that a user is unable to tune in to broadcast 100 until time t20 (e.g., 20 minutes into the live broadcast), the user may still listen to live broadcast 100 in its entirety by initiating buffered playback 102 at time t20. As shown in the present example, buffered playback 102 may occur at the normal speed (1×). As buffered playback 102 is occurring, processing logic 32 may continue to encode the current live broadcast stream 100 while decoding an earlier sample of the buffered data 102. For instance, between times t20 and t40, the portion of live broadcast 100 that broadcasted from time t20 to time t40 is buffered (e.g., encoded) while the previously buffered portion of live broadcast 100 from time t0 to t20 is played back (e.g., decoded). Thus, in this scenario, buffered playback 102 and live broadcast 100 are time-shifted by 20 minutes, such that buffered playback 102 of the entire broadcast 100 occurs from time t20 to time t95 (75 minutes).

The illustrated graphical time of FIG. 4 also shows a power timeline 104 that illustrates power usage by device 10 during the buffering of live broadcast 100 and playback of the buffered data 102 at a normal speed (1×). Referring to Table 1 below, power consumption corresponding to various device operation events are expressed by the variables X, Y, and Z, each representing the consumption of power in units per minute.

TABLE 1
Power Consumption Values (units/minute)

| | Power Consumption |
|---|---|
| Device Operation | (units/minute) |
| Output of Audio Data | X |
| Buffering of Audio Data | Y |
| Playback of Buffered | Z |
| Audio Data | |

As shown in Table 1, the output of audio data (e.g., to audio output device 34), whether it is live or buffered audio, may consume X units/min. Additionally, buffering of audio data (e.g., encoding, compressing, encrypting, and/or storing into memory) may consume Y units/min, and the playback of audio data (e.g., decoding, decompressing, decrypting, and/or reading from memory) may consume Z units/min.

Although the exact values may vary from implementation to implementation, buffering (Y) generally consumes more power than both playback (Z) and output (X), while playback (Z) generally consumes more power than output (X). Thus, in the present embodiment, these values may be expressed by the following relationship: Y>Z>X. Further, while the examples below may refer to a “total power consumption,” it should be understood that the term “total” is meant to apply to device operation events relating to Table 1 above, and may not necessarily take in account other types of non-audio-playback-related device operation events, such as power used to power a display device, network device, make a phone call, and so forth.

With these points in mind and referring still to power timeline 104 of FIG. 4, from time t0 to time t20, device 10 is only buffering live broadcast 100 and, thus consumes Y units/min during this interval, which may be expressed as 20Y units. Between times t20 and t75, device 10 is buffering live broadcast 100, playing back buffered data 102, and outputting buffered data 102. As such, device 10 consumes X+Y+Z units/min for the 55 minute interval from time t20 to t75, which may be expressed as: 55X+55Y+55Z units. Finally, from time t75 to time t95, device 10 is no longer buffering live broadcast 100, which ended at time t75, but continues to playback and output buffered data 102. Accordingly, in this 20 minute interval, device 10 consumes X+Z units/min, expressed as: 20X+20Z units. Thus, based on these power usage values, the total power consumed when buffering and playing back the entire broadcast 100 at the normal speed may be expressed as: 75X+75Y+75Z. As will be illustrated further below, this power consumption value may be reduced by increasing the buffered playback speed in accordance with the synchronization techniques discussed above.

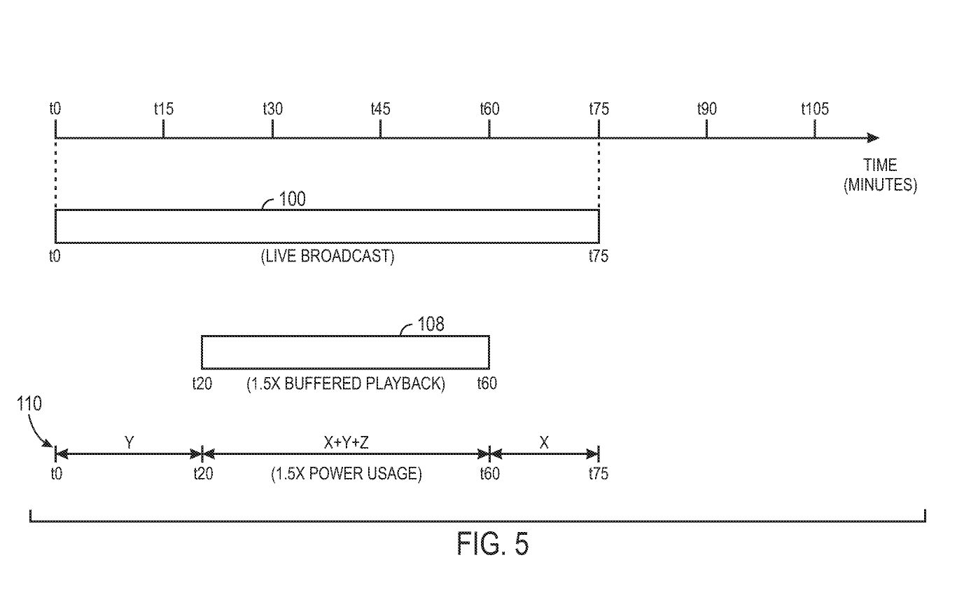

Referring now to FIG. 5, a graphical timeline depicting the same live broadcast 100 from FIG. 4, but showing the buffered playback of live broadcast 100 using an increased playback speed of 1.5× (reference number 108) is illustrated. Assuming again that the user initiates buffered playback at time t20, device 10 may start the buffered playback of the beginning of the live broadcast (corresponding to time t0) at time t20, but at a playback speed of 1.5× relative to the normal speed. In other words, for each minute of real time that passes, 1.5 minutes of buffered audio is played back. As shown in FIG. 5, based on the 1.5× playback speed, buffered playback 108 will synchronize or catch up to live broadcast 100 at time t60. Once the buffered playback 108 and live broadcast are synchronized, device 10 may disable buffering and simply output the received live stream 100.

Power timeline 110 illustrates the reduction of power consumption when using the increased 1.5× playback speed. For instance, from time t0 to time t20, device 10 is only buffering live broadcast 100 and, thus consumes Y units/min during this interval, expressed as 20Y units. Between times t20 and t60, device 10 is buffering live broadcast 100, and playing back and outputting buffered data 102 at the increased 1.5× playback speed. As such, device 10 consumes X+Y+Z units/min for the 40 minute interval from time t20 to t60, expressed as: 40X+40Y+40Z units. Finally, from time t60 to time t75, device 10 is no longer buffering and only outputs live broadcast 100. Thus, power consumption in this 15 minute interval may be expressed as 15X units. Thus, the total power consumed when using the 1.5× buffered playback speed may be expressed as: 55X+60Y+40Z units which, when compared to the buffered playback of live broadcast 100 at normal speed (FIG. 4), reduces power consumption by 20X+15Y+35Z units. As will be appreciated, the savings in power consumption is the result of reducing the total buffering time (e.g., encoding, compressing, encrypting, etc.) and/or the total buffered playback time (e.g., decoding, decompressing, decrypting, etc.). For instance, when compared to the normal buffered playback shown in FIG. 4, the total buffering time in FIG. 5 is reduced from 75 minutes to 60 minutes, and the total buffered playback time is reduced from 75 minutes to 40 minutes.

Additionally, in some embodiments, a user may also have the option of continuing to buffer live broadcast 100 even after synchronization occurs. For instance, this may be desirable when the user wishes to retain a full copy of the live broadcast 100 on device 10 for playback at a later time. In this latter scenario, the power consumed from time t60 to time t75 may be X+Y units/min (to reflect the continued buffering), expressed at 15X+15Y units, and the power consumed in playing back the buffered data 108 and live data 100 may be calculated as 55X+75Y+40Z units, which is a savings of 20X+35ZX units when compared to the buffered playback of live broadcast 100 at normal speed (FIG. 4). Thus, although the total power saved when buffering continues after synchronization is not as great as in the buffered playback scenario 108, in which buffering is turned off after synchronization, the total power usage is still less when compared to the normal (1×) buffered playback shown in FIG. 4.

Before continuing, it should be understood that the use of a 1.5× buffered playback speed in the present figure is merely intended to show one example of an increased buffered playback speed that may be utilized by device 10. Indeed, as mentioned above, depending on a variety of other factors or settings, such as the genre of the audio data (e.g., speech versus music) or user-configured settings 72, different increased playback speeds may also be applied (e.g., 2×, 2.5×, 3×, 3.5×, 4×, 5×, etc.). As will be appreciated, faster buffered playback speeds may enable device 10 to synchronize with live broadcast 100 in a shorter amount of time, thus further reducing power consumption. However, depending on the aesthetic nature of the audio data, a user may want to subjectively balance increasing the playback speed against preserving an acceptable amount of intelligibility in the buffered audio data and, thus, may not always want to select the greatest available playback speed. For instance, as discussed above, an approximately 5 to 10 percent increase in music playback speed may generally be acceptable, while a 100 percent increase (2×) for speech playback is generally acceptable. Additionally, it should be understood that even the buffered playback using the increased playback speed is unable to catch up to the live stream during the live broadcast, at least some amount of power is still saved due to a reduction in total buffered playback time (e.g., reduction in decoding, decompression, decrypting, etc.).

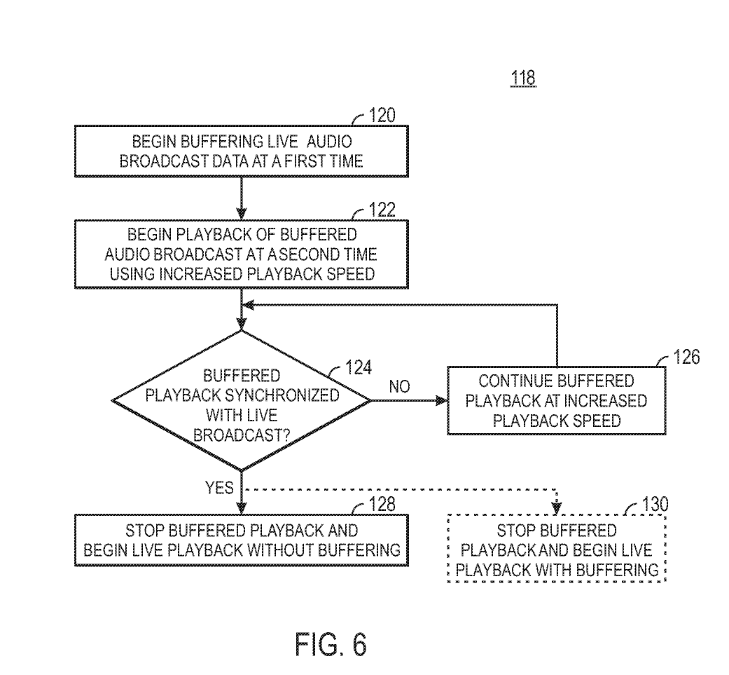

The process of synchronizing buffered playback 108 with live broadcast 100, as shown in FIG. 5, may be further illustrated with reference to FIG. 6, which shows a flowchart depicting method 118, in accordance with aspects of the present disclosure. For instance, method 118 may be implemented by audio broadcast processing logic 32, as discussed above in FIG. 3. Method 118 initially begins at step 120, wherein electronic device 10 begins buffering a live audio broadcast at a first time. For instance, as shown in FIG. 5, electronic device 10, which may receive live broadcast 100 by way of receiver 30, begins buffering live audio broadcast 100 at the start of its scheduled broadcast time t0.

Next, method 100 continues to step 122, which may represent a second time (subsequent to the first time) at which playback of the buffered audio data using an increased playback speed begins. For instance, step 122 may correspond to the start of the buffered playback 108 at time t20, as shown in FIG. 5, using a 1.5× playback speed. Though not specifically shown here, it should be appreciated that pitch adjustment may also be applied to the buffered playback (e.g., via pitch adjustment logic 68) to match the buffered playback with the original pitch of the audio data (e.g., at normal speed 1×). Method 100 then continues to decision block 124, at which a determination is made as to whether the buffered playback has synchronized or caught up with the live broadcast. Referring again to FIG. 5, the synchronization of buffered playback 108 and live broadcast 100 occurs at time t60 when using the 1.5× playback speed. Thus, if it is determined that the buffered playback and live stream are not synchronized (e.g., prior to time t60), then decision block 124 branches to step 126, wherein the buffered playback continues at the increased playback speed. From step 126, method 118 returns to decision block 124.

If, at decision block 124, it is determined that the buffered playback and live steam are synchronized (e.g., at time t60), then method 118 continues to step 128, at which device 10 switches from playing back buffered data to outputting the live broadcast (e.g., via audio output device 34), while also stopping the buffering of data. As discussed above, this may reduce overall power consumption of device 10. Alternatively, a user may also opt to continue buffering the live broadcast even after synchronization occurs. For instance, this option, which is shown by alternative step 130, may be selected if the user wishes to retain a full buffered copy of the live broadcast for playback at a later time.

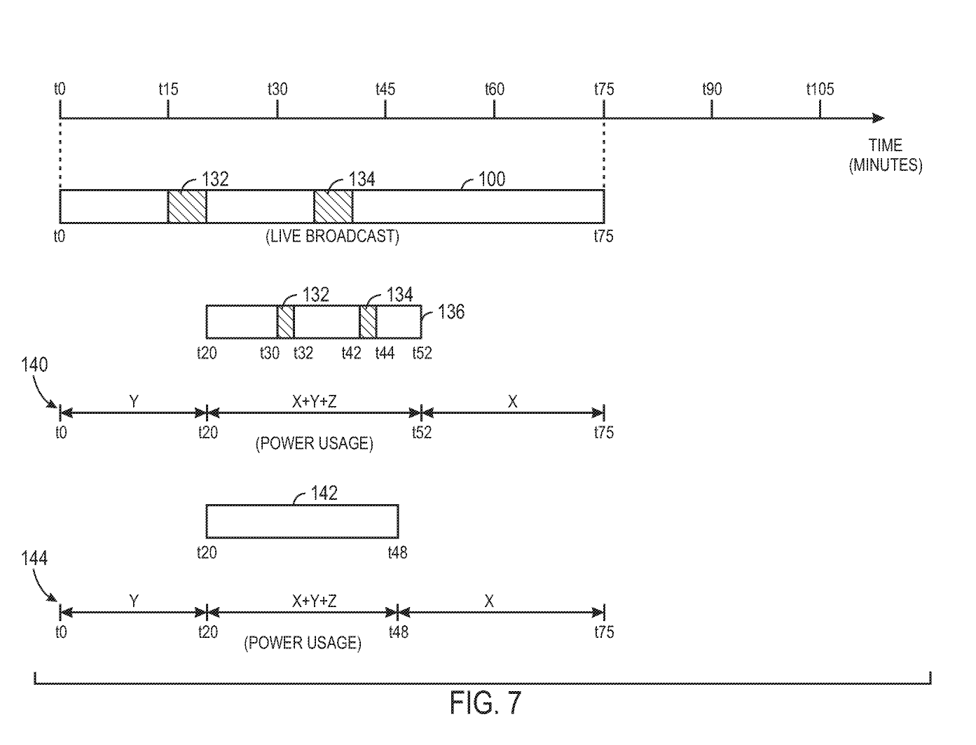

As mentioned above, power consumption using the increased buffered playback techniques disclosed herein may be even further reduced by identifying non-essential portions within the buffered audio data and either playing the non-essential portions at an even greater increased playback speed (e.g., compared to the increased playback speed for essential portions of the buffered audio data) or omitting the non-essential portions from the buffered playback. For example, referring now to FIG. 7, a graphical timeline that depicts: (1) the buffered playback 136 of live broadcast 100 using a first increased playback speed of 1.5× for essential portions and a second increased playback speed of 2.5× for non-essential portions; and (2) buffered playback 142 of live broadcast 100 that omits non-essential portions are illustrated, in accordance with embodiments of the presently described techniques.

Beginning at time t0, device 10 starts buffering live broadcast 100, which may include non-essential portions from time t15 to time t20 (represented by reference number 132), and from time t35 to t40 (represented by reference number 134). Assuming again that the user initiates buffered playback at time t20, device 10 may start the buffered playback 136 of the beginning of the live broadcast (corresponding to time t0) at time t20 using an increased playback speed of 1.5×. As discussed above, at the present playback speed, each minute of buffered playback may correspond to 1.5 minutes of buffered data. Thus, the first 15 minutes of live broadcast (from time t0 to t15) may be played back in 10 minutes (from time t20 to t30), as indicated by buffered playback 136.

Next, because the buffered data that corresponds to non-essential portion 132 (from time t15 to t20) is played back at an increased speed of 2.5×, each minute of buffered playback during this time may correspond to 2.5 minutes of non-essential data. For instance, as shown by buffered playback 136, non-essential portion 132 is played back in two minutes (from time t30 to t32) using the 2.5× playback speed. Buffered playback 136 then returns to the 1.5× playback speed, which is used to play back the following 15 minutes of an essential portion of live broadcast 100 (from time t20 to t35) in the subsequent 10 minutes (from time t32 to t42). Thereafter, non-essential portion 134 (time t35 to t40 of live broadcast 100) is also played back at the greater increased speed of 2.5×, such that the buffered playback of non-essential portion 134 is played back in two minutes (from time t42 to t44). Buffered playback 136 then returns to the 1.5× speed and, at time t52, catches up and synchronizes with live broadcast 100, at which point buffering may be turned off.

As can be appreciated, when compared to the buffered playback of FIG. 5, which uses a constant buffered playback speed of 1.5×, the use of the faster 2.5× speed for non-essential portions (132 and 134) synchronizes buffered playback 136 with live broadcast 100 8 minutes faster, which may provide additional power savings. For instance, referring to power timeline 140, the from time t0 to time t20, 20Y units of power are consumed for buffering live broadcast 100. From time t20 to time t52, 32X+32Y+32Z units of power are consumed for buffering live broadcast 100 and for playing back, and outputting buffered data 136. Then, because synchronization occurs at time t52, the user may stop buffering the live broadcast and simply listen to the live stream. As such, from time t52 to t75 (the end of the broadcast), 23X units of power is consumed for outputting the live stream. Accordingly, the total power consumption when utilizing both the 1.5× and 2.5× playback speeds in combination may be expressed as: 55X+52Y+32Z units. Thus, compared to the normal buffered playback of FIG. 4, buffered playback 136 of FIG. 7 provides a power usage reduction of 20X+23Y+43Z units, which is also 8Y+8Z units less power usage compared to the constant 1.5× buffered playback (108) of FIG. 5.

FIG. 7 also illustrates an embodiment in which buffered playback, referred to by reference number 142, omits the buffered playback of non-essential portions 132 and 134. For instance, when the buffered playback data is identified as non-essential (e.g., via metadata information or signal analysis), buffered playback 142 may skip forward in time to the next segment of essential playback data. Thus, as shown here, by omitting the 2 minutes of buffered playback for each of non-essential portions 132 and 134, synchronization occurs 4 minutes earlier at time t48. As shown in corresponding power timeline 144, from time t0 to time t20, 20Y units of power are consumed for buffering live broadcast 100. From time t20 to time t48, 28X+28Y+28Z units of power are consumed for buffering live broadcast 100 and for playing back, and outputting buffered data 142. From the synchronization time t48 to the end of live broadcast 100 at time t75, 27X units of power is consumed for outputting the live stream. Thus, the total power consumption when omitting the buffered playback of non-essential portions 132 and 134 may be expressed as: 55X+48Y+28Z units, which is an additional reduction in power consumption by 4Y+4Z units when compared to the buffered playback 136.

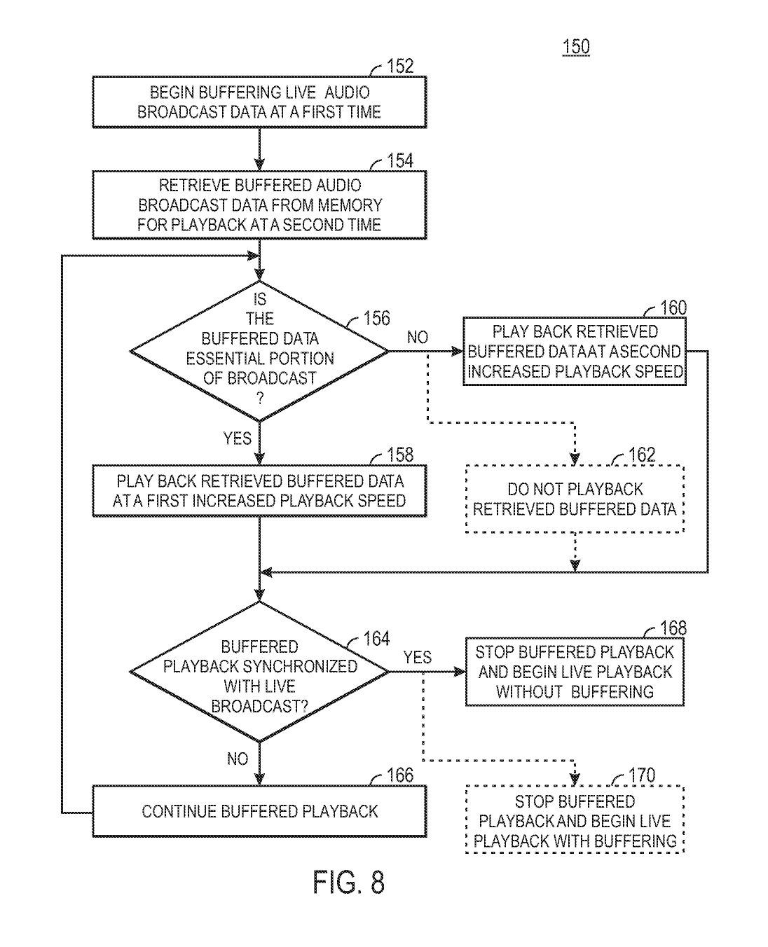

Continuing to FIG. 8, a flowchart depicting method 150, which further illustrates the buffered playback techniques shown in FIG. 7, is provided, in accordance with aspects of the present disclosure. Method 150 initially begins at step 152, wherein electronic device 10 begins buffering a live audio broadcast at a first time, which may correspond to the start of live broadcast 100 (e.g., time t0). Next, at step 154, which occurs at a second time subsequent to the first time (e.g., time t20), buffered audio data is retrieved from storage 20 for playback on device 10. The retrieved buffered audio data is analyzed at decision block 156 to determine whether the retrieved buffered audio data is an essential or non-essential portion of live broadcast 100. If the retrieved buffered audio data is determined to be an essential portion of the broadcast, method 150 continues to step 158, at which the buffered audio data is played back at a first increased speed (e.g., 1.5×). Again, it should be noted that step 158 may also include pitch adjustment (via pitch adjustment logic 68) to match the buffered playback with the original pitch of the audio data (e.g., at normal speed 1×). If the retrieved buffered audio data is determined to be non-essential at decision block 156, method 150 may continue to step 160, at which the buffered audio data is played back at a second increased speed (e.g., 2.5×) that is greater than the first speed, or to alternative step 162, at which the non-essential data is omitted from the buffered playback.

Next, at decision block 164, a determination is made as to whether the buffered playback has synchronized or caught up with the live broadcast. If synchronization has not occurred, buffered playback continues, as shown by step 166. Subsequent to step 166, method 150 returns to decision logic 156 for further evaluation of the buffered audio data. If, at decision block 164, it is determined that the buffered playback and the live steam are synchronized, then method 150 may continue to step 168, at which buffering stops and device 10 plays the live stream. Alternatively, as discussed above, a user may wish to continue buffering the live broadcast even after synchronization occurs. This option is shown by alternative step 170 and may be selected in instances where the user wishes to retain a full buffered copy of the live broadcast for playback at a later time.

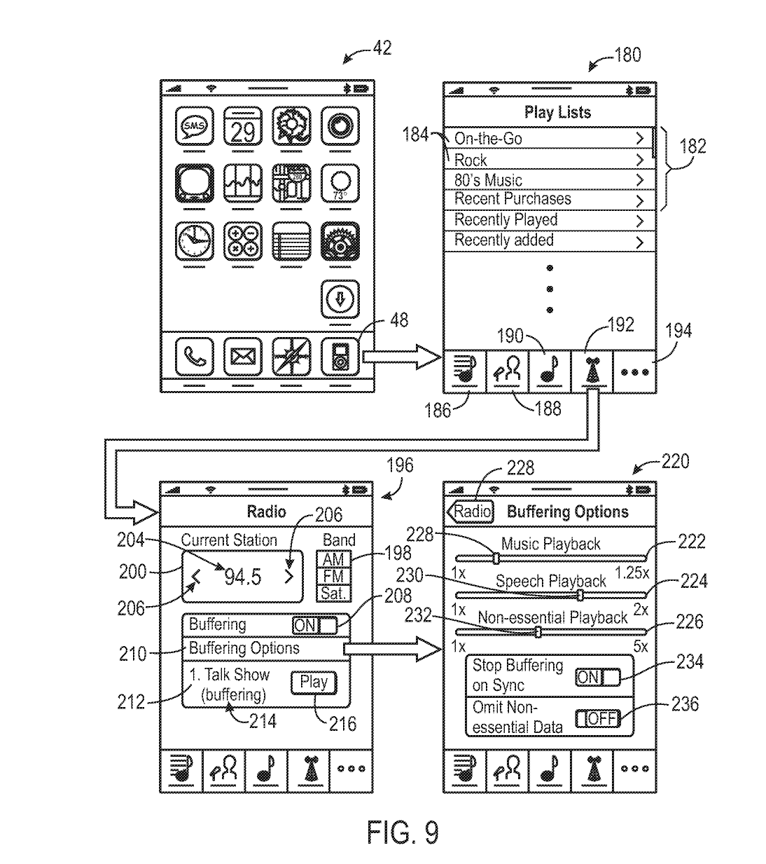

As discussed above, various user settings 72 (FIG. 3), which may at least partially influence the buffered playback of audio data, may be configured on electronic device 10 by a user. For instance, referring now to FIG. 9, an exemplary user interface technique for configuring user settings 72 relating to the buffered playback of audio broadcast data is illustrated, in accordance with aspects of the present disclosure. As will be understood, the depicted screen images may be generated by GUI 45 and displayed on display 28 of device 38. For instance, these screen images may be generated as the user interacts with the device 38, such as via the input structures 14, or by a touch screen interface.

Additionally, it should be understood that GUI 45, depending on the inputs and selections made by a user, may display various screens including icons (e.g., 46) and graphical elements. These elements may represent graphical and virtual elements or “buttons” which may be selected by the user from display 28. Accordingly, it should be understood that the term “button,” “virtual button,” “graphical button,” “graphical elements,” or the like, as used in the following description of screen images below, is meant to refer to the graphical representations of buttons or icons represented by the graphical elements provided on display 28. Further, it should also be understood that the functionalities set forth and described in the subsequent figures may be achieved using a wide variety graphical elements and visual schemes. Therefore, the illustrated embodiments are not intended to be limited to the precise user interface conventions depicted herein. Rather, additional embodiments may include a wide variety of user interface styles.

As initially shown in FIG. 9, beginning from home screen 42 of GUI 45, the user may initiate the media player application by selecting graphical button 48. By way of example, the media player application may be an iTunes® or iPod® application running on a model of an iPod Touch® or an iPhone®, available from Apple Inc. Upon selection of graphical button 48, the user may be navigated to home screen 180 of the media player application, which may initially display listing 182 showing various playlists 184 stored on device 10. Screen 180 also includes graphical buttons 186, 188, 190, 192, and 194, each of which may correspond to specific functions. For example, if the user navigates away from screen 180, the selection of graphical button 186 may return the user to screen 180. Graphical button 188 may organize and display media files stored on device 38 by artist name, whereas graphical button 190 may sort and display media files stored on the device 38 alphabetically. Additionally, graphical button 192 may represent a radio tuner application configured to provide for receiving and buffering of radio broadcast signals. Finally, graphical button 194 may provide the user with a listing of additional options that may be configured to further customize the functionality of device 38 and/or media player application 48.

As shown, the selection of graphical button 192 may advance the user to screen 196, which displays a radio application. Screen 196 may include graphical element 198, which may allow the user to select a particular broadcast source, such as AM, FM, or even satellite-based broadcasting. Screen 196 further includes virtual display element 200, which may display a current radio station 204 and tuning elements 206. By manipulating the tuning elements 208, a user may change the current station 204 from which device 38 is receiving an audio broadcast.

Screen 196 may also provide for the configuration of various user settings 72. For instance, the buffering of audio broadcast data may be configured via graphical switch 208. As shown in the present figure, graphical switch 208 is currently in the “ON” position, thus indicating that buffering is currently enabled. Screen 196 may also include menu option 210, which may navigate the user to another screen for further configuration of buffering options (screen 220). Additionally, screen 196 may display a listing of buffered programs. For instance, the presently displayed screen 196 shows that an audio broadcast program “Talk Show,” referred to by reference number 212, is currently being buffered, as indicated by status indicator 214. To initiate playback of the buffered “Talk Show” program, the user may select graphical button 216.

By selecting menu option 210, the user may be advanced to screen 220, which may display various configurable buffered playback options. For example, screen 220 includes graphical scales 222, 224, and 226, which may be manipulated to configure the buffered playback speed of music data, speech data, and non-essential data, respectively. For instance, to configure the playback speed for buffered music, a user may position graphical element 228 along scale 222 to an appropriate position. In the present embodiment, the buffered playback speed may be increased by sliding the graphical element 228 to the right side of scale 222, and may be decreased by sliding the graphical element 228 to the left side of scale 222. As shown in the present screen 220, the user has configured the buffered playback speed for music to be approximately 6 percent (1.06×) greater than the normal speed (1×). The user may also configure the buffered playback speed for speech audio data and non-essential audio data in a similar manner by positioning graphical element 230 along scale 224 and graphical element 232 along scale 226, respectively. For instance, in the presently illustrated configuration, the buffered playback speed for speech data is set to approximately 1.5×, and the buffered playback speed for non-essential data is set to approximately 2.5×.

Additionally, screen 220 also provides graphical switch 234 by which the user may configure whether to disable buffering once buffered playback is synchronized with the live broadcast, and graphical switch 236, by which the user may configure whether or not to omit non-essential audio data from the buffered playback. As shown, graphical switch 234 is in the “ON” position, and graphical switch 236 is in the “OFF” position. Thus, based on the present configuration, buffering will stop once synchronization occurs, and non-essential data will not be omitted from the buffered playback, although it will be played back at a greater speed (2.5×), as specified by graphical elements 226 and 232. Further, though not shown in the present embodiment, screen 220 could also include graphical elements for configuring pitch adjustment (by pitch adjustment logic 68). Once the desired settings have been selected, the user may select graphical button 238 to return to screen 196. The user may then select graphical button 216 to initiate buffered playback of audio program 212 using the selected settings.

As will be understood, the various techniques described above and relating to the buffered playback of audio broadcast data are provided herein by way of example only. Accordingly, it should be understood that the present disclosure should not be construed as being limited to only the examples provided above. Indeed, a number of variations of the buffered audio playback techniques set forth above may exist. Further, it should be appreciated that the above-discussed techniques may be implemented in any suitable manner. For instance, audio broadcast processing logic 32 of FIG. 3, which is configured to implement various aspects of the present techniques, may be implemented using hardware (e.g., suitably configured circuitry), software (e.g., via a computer program including executable code stored on one or more tangible computer readable medium), or via using a combination of both hardware and software elements.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

What is claimed is:

1. A method, comprising:
initiating the buffering of a live audio broadcast received by an electronic device at a first time;
initiating the buffered playback of the live audio broadcast on the electronic device using an increased playback speed at a second time occurring during the live audio broadcast and subsequent to the first time, wherein the increased playback speed is faster relative to a normal playback speed of the live audio broadcast;
determining if the buffered playback is synchronized with the live audio broadcast; and
if the buffered playback is synchronized with the live audio broadcast, ending the buffering of the live audio broadcast at a third time occurring after the second time, and outputting the remainder of the live audio broadcast beginning at the third time.

2. The method of claim 1, wherein buffering the live audio broadcast comprises:
encoding the live audio broadcast data using a codec; and
storing the encoded live audio broadcast data into a storage device.

3. The method of claim 2, wherein encoding the live audio broadcast data comprises compressing the live audio broadcast data using a compression bit-rate.

4. The method of claim 2, wherein buffering the live audio broadcast comprises encrypting the encoded live audio broadcast data prior to storing the encoded live audio broadcast data into the storage device.

5. The method of claim 2, wherein encoding the live audio broadcast data comprises:
determining if the live audio broadcast data comprises speech data or music data;
using a speech codec to encode the live audio broadcast data if the live audio broadcast data comprises primarily speech data; and
using a music codec to encode the live audio broadcast data if the live audio broadcast data comprises primarily music data.

6. The method of claim 5, wherein using the increased playback speed comprises:
using a playback speed of between approximately 1.05 to 1.10 times the normal playback speed of the live audio broadcast if the live audio broadcast data comprises primarily music data; and
using a playback speed of between approximately 1.25 to 2.0 times the normal playback speed of the live audio broadcast if the live audio broadcast comprises primarily speech data.

7. The method of claim 5, wherein determining if the live audio broadcast data comprises speech data or music data comprises analyzing metadata information associated with the live audio broadcast or performing frequency analysis of the live audio broadcast data, or some combination thereof.

8. The method of claim 5, wherein the music codec comprises an Advanced Audio Coding (ACC) codec, an Apple Lossless Audio codec, an MP3 codec, or any combination thereof, and wherein the speech codec comprises an Adaptive Multi-Rate codec, a Variable Multi-Rate codec, or any combination thereof.

9. The method of claim 1, comprising:
providing a user of the electronic device an option to continue buffering the live audio broadcast even if the buffered playback is synchronized with the live audio broadcast; and
continuing to buffer the live audio broadcast subsequent to the third time if the option is selected.

10. A method, comprising:
initiating the buffering of a live audio broadcast received by an electronic device;
initiating the buffered playback of the live audio broadcast on the electronic device subsequent to the initiation of the buffering, wherein initiating the buffered playback comprises:
selecting a portion of the live audio broadcast to play back;
determining if the selected portion of the live audio broadcast is an essential portion or a non-essential portion of the live audio broadcast;
if the selected portion of the live audio broadcast is an essential portion, playing back the selected portion using a first increased playback speed that is faster relative to a normal playback speed of the live audio broadcast; and
if the selected portion of the live audio broadcast is a non-essential portion, playing back the selected portion using a second increased playback speed that is faster than the first increased playback speed; and
stopping the buffering of the live audio broadcast if the buffered playback becomes synchronized with the live audio broadcast prior to the end of the live audio broadcast and outputting the remainder of the live audio broadcast.

11. The method of claim 10, wherein the first increased playback speed is between approximately 1.05 to 2 times the normal playback speed.

12. The method of claim 10, wherein the buffered playback of the non-essential portion using the second increased playback speed is perceived as being substantially unintelligible by a user of the electronic device.

13. The method of claim 10, wherein the second increased playback speed is at least greater than twice the normal playback speed.

14. The method of claim 10, wherein the non-essential portion comprises a commercial advertisement or DJ speech, or some combination thereof.

15. The method of claim 10, comprising adjusting the pitch of the buffered playback of the essential portion at the first increased playback speed to approximately match the pitch of the essential portion if it were played back at the normal playback speed.

16. The method of claim 10, wherein the determination of whether the selected portion of the live audio broadcast is an essential portion or a non-essential portion comprises analyzing metadata information associated with the live audio broadcast, wherein the metadata information is provided by a Radio Data System (RDS) signal, an Amplitude Modulation Signaling System (AMSS) signal, a Program Associated Data (PAD) signal, or a Program Service Data (PSD) signal, or some combination thereof.

17. An electronic device, comprising:
an audio broadcast receiver configured to receive a live audio broadcast;
an audio output device configured to output audio data;
a storage device configured to store data; and
processing logic configured to buffer the live audio broadcast at a first time and to playback the buffered live audio broadcast data at a second time subsequent to the first time, wherein the processing logic comprises:
encode/decode logic configured to encode the live audio broadcast data using a codec during buffering and to decode the live audio broadcast data using the codec during playback; and
playback speed management logic configured to play back the buffered live audio broadcast data at a first increased playback speed by outputting the buffered live audio broadcast data using the audio output device, wherein the first increased playback speed is faster relative to a normal playback speed of the live audio broadcast;
wherein the processing logic is configured to stop the buffering of the live audio broadcast upon detecting that the buffered playback is synchronized with the live audio broadcast at a third time subsequent to the second time, and to output the live audio broadcast using the audio output device beginning at the third time.

18. The electronic device of claim 17, wherein the processing logic comprises pitch adjustment logic configured to adjust the pitch of the buffered live audio broadcast during buffered playback using the first increased playback speed, such that the adjusted pitch of the buffered live audio broadcast approximately matches the pitch of the live audio broadcast when played at the normal playback speed.

19. The electronic device of claim 18, wherein the pitch adjustment logic is configured to adjust the pitch of the buffered live audio broadcast using a time-stretching algorithm.

20. The electronic device of claim 17, wherein the processing logic is configured to determine whether a selected portion of the live audio broadcast is an essential portion or non-essential portion of the live audio broadcast, and wherein the playback speed management logic is configured to play back essential portions of the live audio broadcast using the first increased playback speed and to play back non-essential portions of the live audio broadcast using a second increased playback speed, wherein the second increased playback speed is faster than the first increased playback speed.

21. The electronic device of claim 20, wherein the first increased playback speed is between approximately 1.05 and 2 times the normal playback speed, and wherein the second increased playback speed is greater than 2 times the normal playback speed.

22. The electronic device of claim 21, comprising a display device, wherein the first increased playback speed and the second increased playback speed are selectable by a user of the electronic device using a configuration screen accessible through a graphical user interface displayable on the electronic device using the display device.

23. The electronic device of claim 22, wherein the configuration screen is part of a media player application configured to run on the electronic device.

24. The electronic device of claim 21, wherein the configuration screen displays an option to continue buffering the live audio broadcast subsequent to the detection of synchronization at the third time.

25. The electronic device of claim 17, comprising encryption logic configured to encrypt the buffered live audio broadcast data prior to being stored in the storage device, and to decrypt the buffered live audio broadcast data during buffered playback.

26. The electronic device of claim 25, wherein the encryption logic is configured to encrypt the buffered live audio broadcast data using an Advanced Encryption Standard (AES) format or a Data Encryption Standard (DES) format, or some combination thereof.

27. The electronic device of claim 17, wherein the audio output device comprises internal speakers integrated with the electronic device, external speakers connected to the electronic device using an audio connection port, or a headset connected to the electronic device using the audio connection port, or some combination thereof.

28. One or more tangible computer-readable storage media having instructions encoded thereon for execution by a processor, the instructions comprising:
code to cause a live audio broadcast received by an electronic device to begin being buffered at a first time; and
code to cause the buffered live audio broadcast data on the electronic device to be played back begin at a second time subsequent to the first time and occurring during the live audio broadcast, wherein the code for causing the playback of the buffered live audio broadcast data comprises:
code to determine if a selected portion of the live audio broadcast is an essential or non-essential portion of the live audio broadcast;
code to cause the selected portion of the live audio broadcast to be played back using an increased playback speed if the selected portion is determined to be an essential portion of the live audio broadcast; and
code to cause the selected portion of the live audio broadcast to be omitted from the buffered playback if the selected portion is determined to be a non-essential portion of the live audio broadcast.

29. The one or more tangible computer-readable storage media of claim 28, wherein the code for determining if a selected portion of the live audio broadcast is an essential or non-essential portion of the live audio broadcast comprises code to analyze metadata information associated with the live audio broadcast.

30. The one or more tangible computer-readable storage media of claim 28, comprising:
code to stop the buffering of the live audio broadcast upon detecting that the buffered playback is synchronized with the live audio broadcast; and
code to cause the output of the live audio broadcast upon detecting the synchronization.
